(19) United States
(12) Patent Application Publication
(10) Pub. No.: US 2008/0111727 A1
(43) Pub. Date: May 15, 2008

(54) APPARATUS AND METHOD FOR KEY MAPPING IN BLUETOOTH DEVICE

(75) Inventor: Tae-Young KIM, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/935,905

(22) Filed: Nov. 6, 2007

(30) Foreign Application Priority Data
Nov. 9, 2006 (KR) 2006-110266

(51) Int. Cl. G08C 19/16

(52) U.S. Cl. 341/176

(57) ABSTRACT

Provided is an apparatus and method for key mapping. The method for key mapping setting in a Bluetooth device includes determining a key of another Bluetooth device that is to be mapped and a predetermined function with respect to the key, setting the function of the key to the predetermined function, and storing information on the key and the predetermined function. Accordingly, functions of an existing Audio/Video Remote Control Profile (AVRCP) controller can be mapped onto predetermined functions when the Bluetooth device does not include the AVRCP controller that provides predetermined functions.

### PRIORITY

This application claims priority under 35 U.S.C. §119(a) to an application filed in the Korean Intellectual Property Office on Nov. 9, 2006 and assigned Serial No. 2006-110266, the contents of which are incorporated herein by reference.

### BACKGROUND OF THE INVENTION

1. Field of the Invention

The present invention relates generally to an apparatus and method for key mapping, and in particular, to an apparatus and method for mapping the function of a key onto a predetermined function in a Bluetooth device.

2. Description of the Related Art

Current electronic devices generally use short distance wireless communication protocols such as InfraRed Data Association (IrDA) or Bluetooth® (hereinafter, “Bluetooth”) for short distance communications with other external devices. Recently, among such protocols, Bluetooth is widely used.

FIGS. 1A and 1B illustrate wireless communication processes between conventional Bluetooth devices.

Referring to FIG. 1A, a Bluetooth remote controller controls a Bluetooth portable Disc player to play a music file. The portable Disc player sends the played music file to a Bluetooth headphone. When Bluetooth protocol defines and supports an Audio Video Remote/Control Profile (AVRCP), Bluetooth devices can be controlled using the Bluetooth protocol FIG. 1B illustrates a Bluetooth portable Disc player and a Bluetooth headphone with a remote controller.

Bluetooth standard specifications define the AVRCP for controlling external devices. The AVRCP includes most command codes used in conventional remote controllers. However, due to size restrictions imposed on commercial Bluetooth remote controllers, the remote controllers can support only a portion of the command codes.

FIG. 2 illustrates a procedure of an Audio/Video Control (AV/C) command between conventional Bluetooth devices. In FIG. 2, “CT” denotes a Bluetooth controller and “TG” denotes a Bluetooth target.

Referring to FIG. 2, when the AVRCP is used for controlling the Bluetooth devices, they are controlled by using an AV/C command set based on an Audio/Video Control Transport Protocol (AVCTP).

The AV/C command set includes various command subsets. A “PASS THROUGH” command set that is subordinate to a “VENDOR DEPENDENT” command set may be used as a subunit command set to control Bluetooth devices.

The CT sends an AV/C command as a control command to the TG, and then the TG may return “AV/C interim response” or “AV/C response”.

The PASS THROUGH command set defines four categories. The category 1 defines PASS THROUGH commands for “play”, “stop”, etc. of a player/recorder. The category 2 defines PASS THROUGH commands for “volume up”, “volume down”, etc. of a monitor/amplifier. The category 3 defines PASS THROUGH commands for “channel up”, “channel down”, etc. of a tuner. Finally, The category 4 defines PASS THROUGH commands for “root menu”, “up”, “down”, “left”, “right”, “select”, etc. of a menu function, i.e., On-Screen Display (OSD) menu.

FIG. 3 is an exemplary table of operation IDentifications (IDs) in levels that can be supported by conventional TGs.

Referring to FIG. 3, a capital letter ‘C’ denotes a category and a numeral following the capital letter ‘C’ denotes a level. The combination of the two characters, e.g. “C1”, denotes that an operation ID is supported in the corresponding category and level. The TG receives an AV/C command including the corresponding operation ID and performs the corresponding function.

When considering a Bluetooth stereo headphone with a remote controller, due to capacity restrictions imposed on a user interface, the remote controller generally supports basic control commands such as “play”, “stop”, fast forward (hereinafter, “ff”), and rewind (hereinafter, “rew”) that are appropriately selected for a predetermined use.

In a case when a portable terminal, which supports Digital Multimedia Broadcasting (DMB) and Bluetooth broadcasting, is linked with a Bluetooth stereo headphone with a remote controller that supports a portion of control commands, if the portable terminal supports a TeleVision (TV)-Out function and allows a TV to display a received DMB program on its screen, the portable terminal may be generally placed next to the TV and a user may watch the DMB program at a certain distance from the portable terminal.

In the case, when the user changes a DMB channel or adjusts a volume, the user must move to the portable terminal and perform the control operations manually, if the remote controller does not support desired control commands.

What is therefore required is an apparatus and method for mapping the functions of Bluetooth controller's keys, which are not currently used, onto desired functions when the Bluetooth controller does not support the desired control functions.

### SUMMARY OF THE INVENTION

An aspect of the present invention is to substantially solve at least the above problems and/or disadvantages and to provide at least the advantages below. Accordingly, an aspect of the present invention is to provide an apparatus and method for key mapping in a Bluetooth device.

Another aspect of the present invention is to provide an apparatus and method for mapping control commands that are not currently used onto predetermined control commands when a Bluetooth controller supports the predetermined control commands.

Still another aspect of the present invention is to provide an apparatus and method for allowing a user to map the function of a control command corresponding a key onto a predetermined function by using a control command conversion/mapping table included in a Bluetooth target that supports an AVRCP.

According to one aspect of the present invention, a method for key mapping setting in a first Bluetooth device includes determining a key of a second Bluetooth device that is to be mapped and a predetermined function with respect to the key; setting a function of the key to the predetermined function; and storing information on the key and the predetermined function.

According to another aspect of the present invention, a method for key mapping in a first Bluetooth device includes receiving a key input signal transmitted by a second Bluetooth device; determining whether a function corresponding to the key input signal is converted into a predetermined function; and performing the predetermined function in response to the key input signal when the function corresponding to the key input signal is converted into the predetermined function.

According to still another aspect of the present invention, an apparatus for key mapping in a Bluetooth device includes an interface module for processing received data and control commands to provide them, and processing the provided data and control commands to transmit them; a control command conversion management unit for converting a received control command into a predetermined control command when the control command received through the interface module must be converted into the predetermined control command in accordance with previously set information, and a storage unit for storing conversion information on whether the control command conversion management unit converts the received control command into a predetermined control command.

According to even another aspect of the present invention, a system for key mapping in a Bluetooth device includes a first Bluetooth device for transmitting a control command corresponding to a key input when the key input is made; and a second Bluetooth device for receiving the control command, converting the received control command into a predetermined control command when the received control command must be converted into the predetermined control command based on preset information, and executing the predetermined control command.

### BRIEF DESCRIPTION OF THE DRAWINGS

The above and other aspect, features and advantages of the present invention will become more apparent from the following detailed description when taken in conjunction with the accompanying drawings in which:

FIGS. 1A and 1B illustrate wireless communication processes between conventional Bluetooth devices;

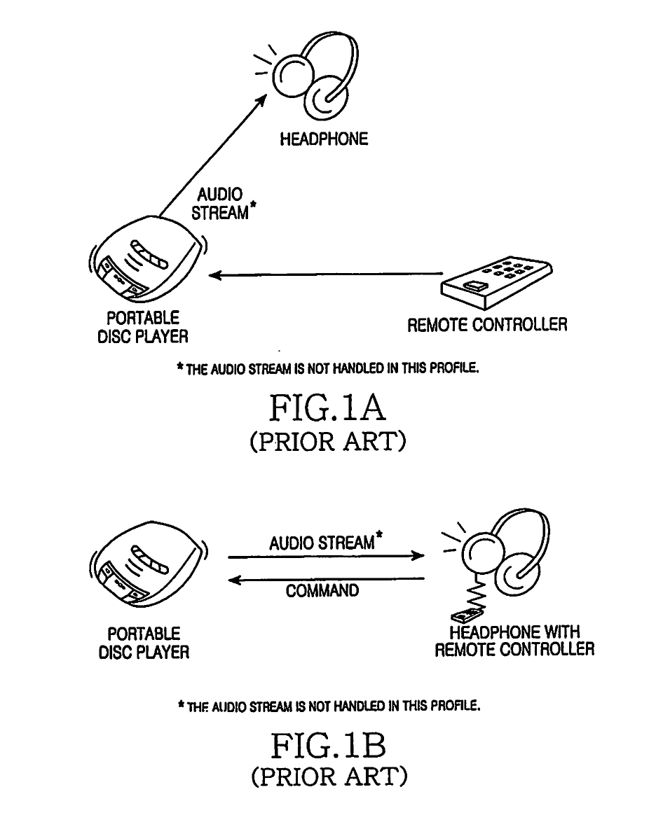

FIG. 2 illustrates a procedure of an AV/C command between conventional Bluetooth devices;

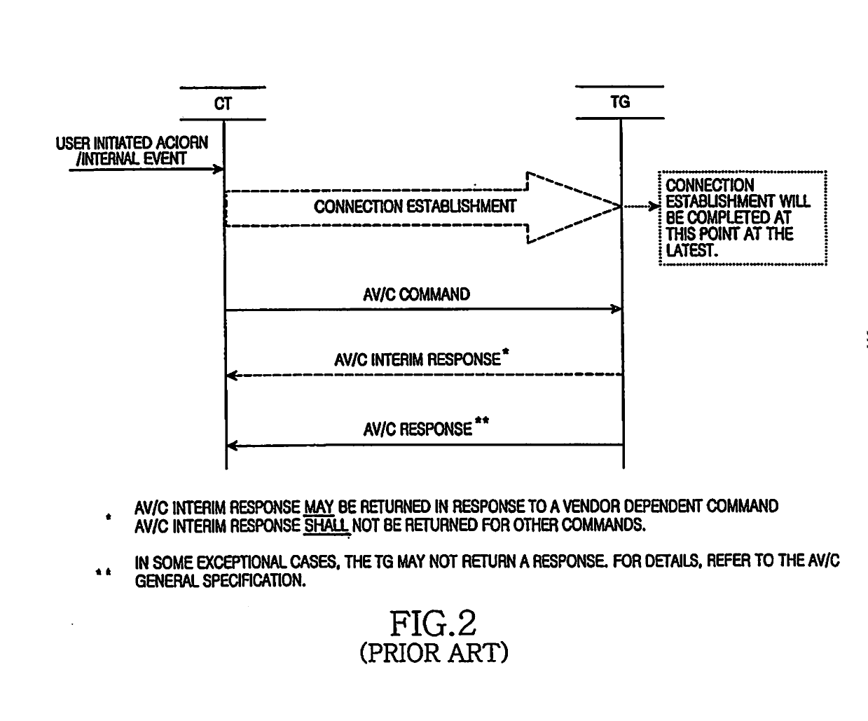

FIG. 3 is an exemplary table of operation IDs in levels that can be supported by a conventional TG;

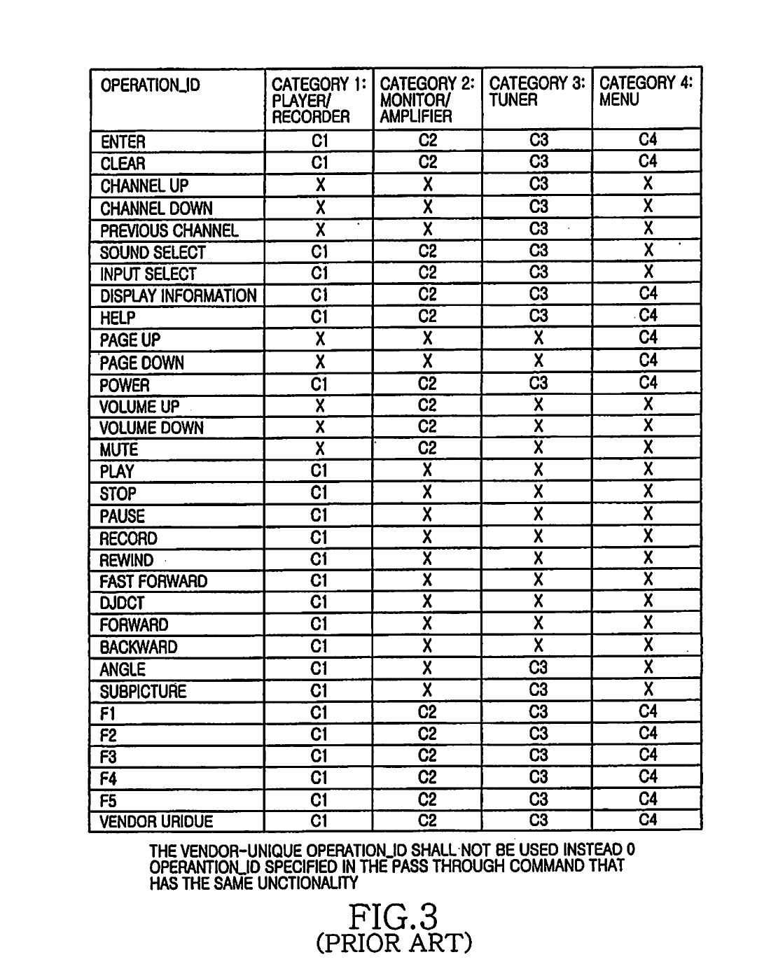

FIG. 4 is a block diagram illustrating key mapping process between Bluetooth devices according to an embodiment of the present invention;

FIG. 5 is a flow diagram illustrating a key mapping process in a TG according to an embodiment of the present invention;

FIG. 6 is a flow diagram illustrating a key mapping setting process in a Bluetooth device according to an embodiment of the present invention; and

FIG. 7 is a block diagram of a Bluetooth device according to an embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, a description will be given of an apparatus and method for key mapping in Bluetooth devices according to the present invention.

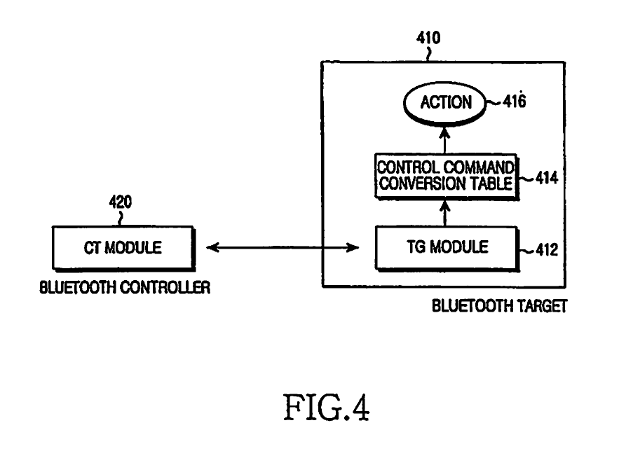

FIG. 4 is a block diagram illustrating key mapping process between Bluetooth devices according to an embodiment of the present invention.

Referring to FIG. 4, the key mapping process for a control command of the AVRCP is illustrated in a Bluetooth target 410 (hereinafter, “TG”). The control command is transmitted from a Bluetooth controller 420 (hereinafter, “CT”). For the key mapping process, a control command conversion table 414 is required. Consequently, an action 416, which corresponds to a predetermined control command mapped through the key mapping process, is performed. For example, the function of a Fast Forward (FF) key is converted into the function of a volume up key according to the control command conversion table. i.e., when the FF key is pressed, the volume level is increased.

Such a mapping setting according to the control command conversion table is performed by a TG module 412. The mapping setting may be previously performed for each CT. For example, when the TG is in a TV-Out state and the CT is a Bluetooth stereo headset, an FF key and a REWind (REW) key of the Bluetooth stereo headset may be set to perform actions corresponding to a channel up key and a channel down key, respectively.

In another way, the mapping setting may be directly performed by a user on the TG module 412. For example, the mapping setting may be performed using a user interface of the TG 410 that provides the function settings determining what keys of which CT device perform which functions. The user interface must be also implemented.

In still another way, the mapping setting may be interactively performed. While the TG is in a TV-Out state, a user may set the function of a key of the CT in real time.

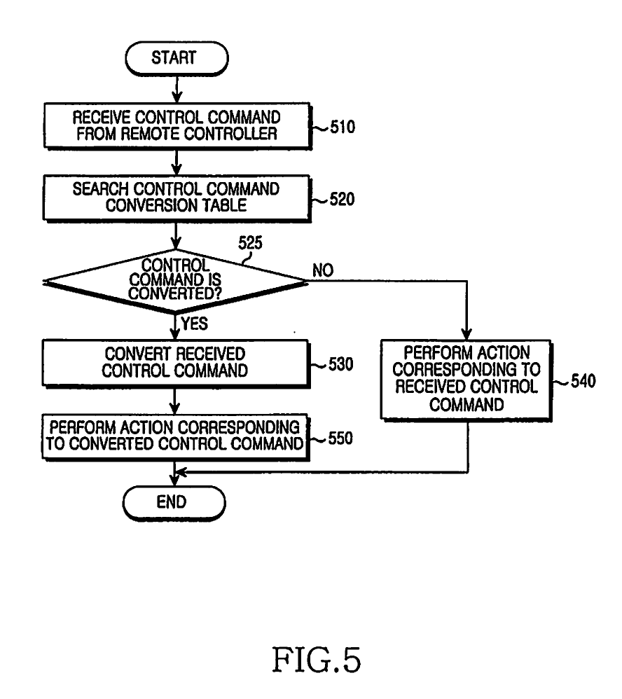

FIG. 5 is a flow diagram illustrating a key mapping process in a TG according to an embodiment of the present invention.

Referring to FIG. 5, in step 510, the TG receives a control command from a remote controller. In step 520, the TG searches a control command conversion table.

When the remote controller is not eligible for command conversion and the received control command is not stored in the control command conversion table in step 525, an action corresponding to the received control command is performed in step 540.

On the contrary, when the remote controller is eligible for command conversion and the received control command is stored in the control command conversion table in step 525, the received control command is converted into a predetermined control command in step 530. Thereafter, an action corresponding to the predetermined control command obtained through such a control command conversion process is performed in step 550.

The control command conversion process, i.e., a mapping setting, is performed by the target. A mapping setting may be previously performed for each remote controller. For example, when the TG is in a TV-Out state and a remote controller is a Bluetooth stereo headset, an FF key and an REW key of the Bluetooth stereo headset may be set to perform actions corresponding to a channel up key and a channel down key.

In another way, the mapping setting may be directly performed by a user on the TG For example, the mapping setting may be performed using a user interface of the TG that provides the function settings determining what keys of which CT device perform which functions. The user interface must be also implemented.

In still another way, the mapping setting may be interactively performed. While the TG is in a TV-Out state, a user may set the function of a key of the remote controller in real time.

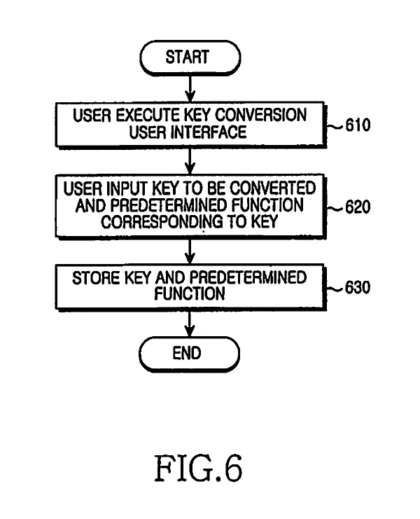

FIG. 6 is a flow diagram illustrating a key mapping setting process in a Bluetooth device according to an embodiment of the present invention.

Referring to FIG. 6, in step 610, a user instructs the execution of a user interface for key mapping. The user interface must be also implemented.

A key that is to be converted is inputted from the user. In addition, a predetermined function, into which the key's original function is to be converted, is inputted from the user. In other words, the original function of the key is mapped to the predetermined function by the user in step 620.

In step 630, information on the key and the predetermined function are stored.

Then, the process is terminated.

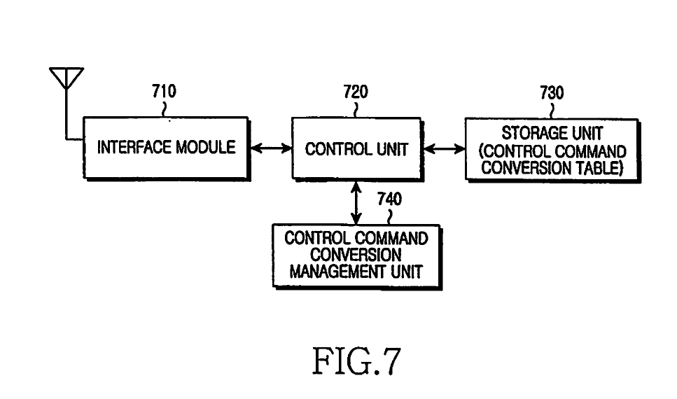

FIG. 7 is a block diagram of a Bluetooth device according to an embodiment of the present invention.

Referring to FIG. 7, the Bluetooth device includes an interface module 710, a control unit 720, a control command conversion management unit 740, and a storage unit 730.

The interface module 710 includes a RF processor and a baseband processor to receive data or a control command transmitted from another node. The RF processor converts a signal received through an antenna into a baseband signal to provide the converted signal to the baseband processor.

A control unit 720 controls the whole operations of the Bluetooth device. That is, the control unit 720 controls the Bluetooth device based on data and a control command received from another Bluetooth device, e.g., a remote controller. In addition, the control unit 720 provides the received control command to a control command conversion management unit 740, and also receives a control command from the control command conversion management unit 740 to perform an action corresponding the control command.

According to information and an instruction from the control unit 720, the control command conversion management unit 740 searches a control command conversion table and determines whether the control command provided from the control unit 720 is to be converted. If the provided control command is to be converted, the provided control command is converted based on the control command conversion table, and then the converted control command is provided to the control unit 720.

In addition, the control command conversion management unit 740 receives a control command that is to be converted, and stores the control command in the control command conversion table. Such a mapping setting may be previously performed for each CT. In another embodiment, setting the mapping may be directly performed by a user on the Bluetooth device. For example, the mapping setting may be performed using a user interface of the Bluetooth device that provides the function settings determining what keys of which CT device perform which functions. The user interface must be also implemented. In still another way, the mapping setting may be interactively performed. A user may set the function of a key of another Bluetooth device in real time.

The storage unit 730 stores a program for controlling the entire operation of the Bluetooth device and temporary data generated during the execution of the program. In addition, the storage unit 730 includes the control command conversion table according to the present invention.

In the above-described configuration, the control unit 720 may perform the functions of the control command conversion management unit 740. Although separate units are provided for describing the respective functions of the control unit 720, the control unit 720 may be designed to perform all or some of the functions of the control command conversion management unit 740.

As described above, the present invention provides the key mapping apparatus and method for mapping functions of an existing AVRCP controller onto predetermined functions when a Bluetooth device does not include the AVRCP controller that provides predetermined functions.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for key mapping setting in a first Bluetooth device, comprising the steps of:
determining a key of a second Bluetooth device that is to be mapped and a predetermined function with respect to the key;
setting a function of the key to the predetermined function; and
storing information on the key and the predetermined function.

2. The method of claim 1, wherein setting the function of the key comprises:
converting a control command into a predetermined control command, the control command being executed in response to an input of the key.

3. The method of claim 1, wherein storing the information comprises:
storing conversion information on converting a control command into a predetermined control command, the control command being executed in response to an input of the key.

4. The method of claim 1, wherein the key of the second Bluetooth device and the predetermined function with respect to the key are determined by at least one of a user and a manufacturer.

5. The method of claim 4, wherein the key of the second Bluetooth device and the predetermined function with respect to the key are set by the user using a user interface.

6. A method for key mapping in a first Bluetooth device, comprising the steps of:
receiving a key input signal transmitted by a second Bluetooth device;
determining whether a function corresponding to the key input signal is converted into a predetermined function; and
performing the predetermined function in response to the key input signal when the function corresponding to the key input signal is converted into the predetermined function.

7. The method of claim 6, wherein the step of determining comprises:
determining whether to convert the function corresponding to the key input signal by searching a control command conversion table that stores conversion information on converting a control command into a predetermined control command, the control command being executed in response to the key input signal.

8. The method of claim 6, wherein performing the predetermined function comprises:
executing a predetermined control command into which a control command corresponding to the key input signal is converted.

9. An apparatus for key mapping in a Bluetooth device, comprising:
an interface module for processing received data and control commands to provide them, and processing the provided data and control commands to transmit them;
a control command conversion management unit for converting a received control command into a predetermined control command when the control command received through the interface module must be converted into the predetermined control command in accordance with preset information, and
a storage unit for storing conversion information on whether the control command conversion management unit converts the received control command into a predetermined control command.

10. The apparatus of claim 9, wherein the control command conversion management unit converts a control command transmitted from another Bluetooth device into a predetermined control command based on the conversion information when the control command conversion management unit searches the conversion information stored in the storage unit to detect the transmitted control command to be converted.

11. The apparatus of claim 9, wherein the conversion information is stored by at least one of a user and a manufacturer, the conversion information on whether to convert the received control command.

12. The apparatus of claim 11, wherein a key of another Bluetooth device that is to be mapped and a predetermined function with respect to the key are set by the user using a user interface.

13. A system for key mapping in a Bluetooth device, comprising:
a first Bluetooth device for transmitting a control command corresponding to a key input when the key input is made; and
a second Bluetooth device for receiving the control command, converting the received control command into a predetermined control command when the received control command must be converted into the predetermined control command based on preset information, and executing the predetermined control command.

14. The system of claim 13, wherein conversion information is stored by at least one of a user and a manufacturer, and the conversion information is the preset information, which determines whether the received control command is converted into a predetermined control command.

15. The system of claim 14, wherein a key of another Bluetooth device that is to be mapped and a predetermined function with respect to the key are set by the user using a user interface.
